(19) United States
(12) Patent Application Publication
(10) Pub. No.: US 2013/0346171 A1
(43) Pub. Date: Dec. 26, 2013

(54) INCENTIVIZED COMMUNICATIONS WITHIN SOCIAL NETWORKS

(71) Applicant: Jay W. Wright, Nichols Hills, OK (US)

(72) Inventor: Jay W. Wright, Nichols Hills, OK (US)

(21) Appl. No.: 13/531,572

(22) Filed: Jun. 24, 2012

(51) Int. Cl. G06Q 30/02

(52) U.S. Cl. 705/14.16

(57) ABSTRACT

Incentivized social communications technologies are provided herein. According to some embodiments, methods for exchanging rewards for personal endorsements on a social network may include receiving, via a server, an offer from a provider, the offer including criteria for receiving a reward, the criteria at least including requirements for an endorsement of the provider that is to be placed on at least one social network, providing the offer to an endorser, and also providing a reward to the endorser upon confirmation of placement of the endorsement on the social network.

### FIELD OF THE PRESENT TECHNOLOGY

The present technology relates generally to social networks and marketing, and more specifically, but not by way of limitation, to systems and methods that facilitate incentivized communications within social networks, also known as incentivized social advertising. According to some embodiments, the present technology may comprise an exchange that facilitates the provision of rewards in trade for consumer messages (e.g., endorsements) communicated via social networks.

### BACKGROUND

Marketing and advertising of goods and services are ubiquitous activities on social networks. Additionally, end users of social networks may provide opinions relative to goods and services offered by merchants. This type of electronic word-of-mouth advertising by end users is highly persuasive and effective in communicating and building brand recognition. What is needed are solutions that bridge the gap between end users of social networks and merchants who wish to advertise their goods and/or services on social networks, as well as increase goodwill within their current and potential consumer base.

### SUMMARY OF THE PRESENT TECHNOLOGY

According to some embodiments, the present technology may be directed to an exemplary method for exchanging rewards for personal endorsements on a social network. The method may comprise: (a) receiving, via a server, an offer from a provider, the offer comprising criteria for receiving a reward, the criteria at least comprising requirements for an endorsement of the provider that is to be placed on at least one social network; (b) providing the offer to an endorser; and (c) providing a reward to the endorser upon confirmation of placement of the endorsement on the social network.

According to other embodiments, the present technology may be directed to an exemplary system for exchanging rewards for personal endorsements on a social network. The system may comprise: (a) a memory for storing executable instructions; (b) a processor for executing the executable instructions stored in memory, the executable instructions comprising: (i) an offer module stored in memory and executable by the processor to: (a) receive an offer from a provider, the offer comprising criteria for receiving a reward, the criteria at least comprising requirements for a personalized endorsement of the provider that is to be placed on at least one social network; and (b) provide the offer to an endorser; (ii) an analysis module stored in memory and executable by the processor to determine completion of the criteria; and (iii) a provisioning module stored in memory and executable by the processor to provide a reward to the endorser upon the placement of the personalized endorsement on the social network.

According to additional embodiments, the present technology may be directed to an exemplary method for incentivizing sharing of promotional messages. The method may comprise: (a) providing an offer to an endorser, the offer comprising criteria for receiving a reward, the criteria at least comprising requirements for a promotional message for a provider that is to be communicated to at least one third party via a social network account of the endorser; and (b) providing a reward to the endorser upon the communication of the promotional message to the at least one third party.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 illustrates an exemplary architecture for practicing aspects of the present technology.

FIG. 2 includes block diagrams of an exemplary client-side application and a server-side application, for practicing aspects of the present technology.

FIG. 3 is a graphical user interface in the form of an exemplary offer page.

FIG. 4 is a graphical user interface in the form of another exemplary offer page.

FIG. 5 is a graphical user interface in the form of an exemplary criteria verification popup.

FIG. 6 is a view of a portion of another social network feed for a particular end user.

FIG. 7 is a graphical user interface in the form of an exemplary virtual reward.

FIG. 8 is an exemplary view of an exemplary map that includes location based offers from promoters.

FIG. 9 is an exemplary flow diagram of data through a cloud-based exchange node.

FIG. 10 is a block diagram of an exemplary computing system for implementing embodiments of the present technology.

### DETAILED DESCRIPTION OF EXEMPLARY EMBODIMENTS

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

Generally speaking, the present technology may be described as facilitating incentivized communications on social networks. More specifically, but not by way of limitation, the present technology allows current consumers, potential consumers, and providers (e.g., merchants) to participate in the exchange of rewards for general or specific types of communications placed on social networks. In sum, the present technology provides for the placement of incentivized communications on social networks by consumers. Consumers may function as social network spokespersons for merchants, allowing merchants to spread positive marketing and branding communications regarding the merchant and/or their products or services using the exponential communicative power of the social network. Thus, the present technology leverages the power of electronic word-of-mouth advertising that is available by way of social network communications.

According to various embodiments, the present technology may exchange rewards for personal endorsements on a social network by receiving an offer from a provider. In some instances, the offer may comprise criteria for receiving a reward and the criteria may comprise at least requirements for an endorsement of the provider that is to be placed on at least one social network. The present technology may provide the offer to an endorser and providing a reward to the endorser upon confirmation of placement of the endorsement on the social network.

According to some embodiments, the present technology may incentivize the sharing of promotional messages by providing an offer to an endorser. The offer may comprise criteria for receiving a reward and the criteria may at least comprise requirements for a promotional message for a provider that is to be communicated to at least one third party. Additionally, the present technology may provide a reward to the endorser upon the communication of the promotional message to the at least one third party.

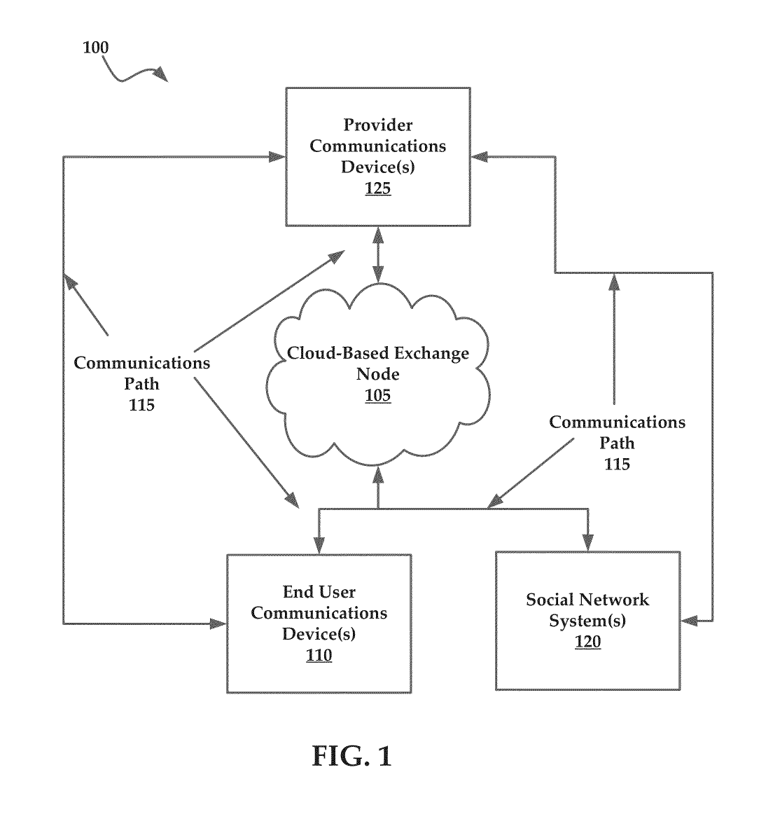

These and other advantages of the present technology will be described in greater detail below with reference to the collective drawings (e.g., FIGS. 1-10).

FIG. 1 illustrates an exemplary architecture 100 for practicing aspects of the present technology. According to some embodiments, the exemplary architecture 100, hereinafter “architecture 100,” may generally include a cloud-based exchange node, hereinafter “node 105” that facilitates incentivized personal advertising, as well as many other features, which will be described in greater detail below.

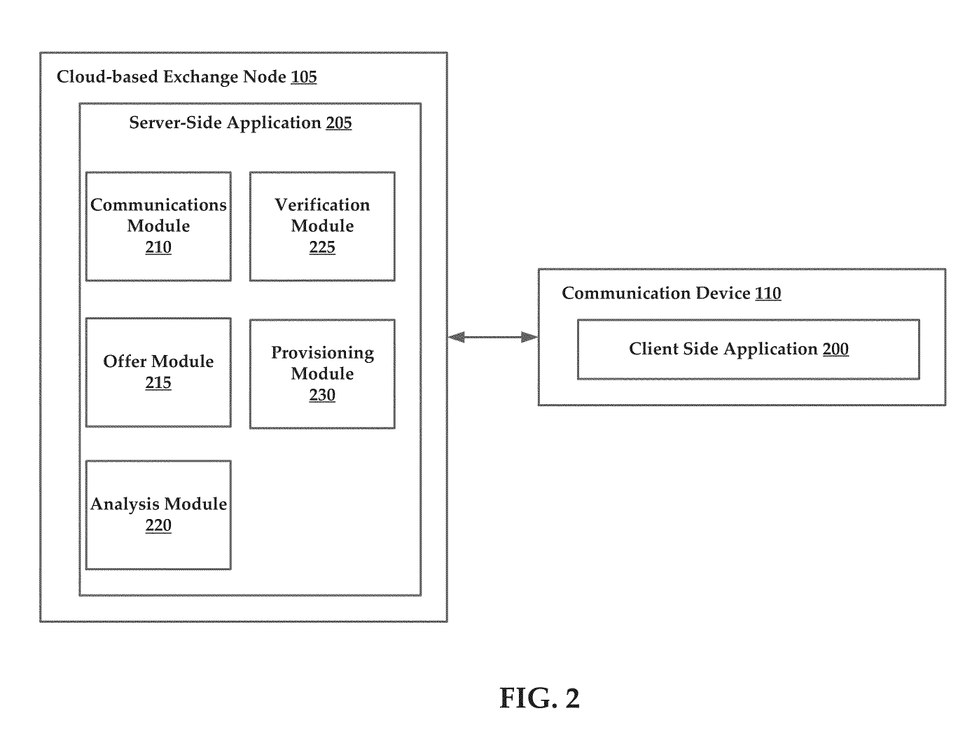

End users (e.g., consumers, clients, potential consumers, social media users, etc.) may interact with the node 105 using a communications device 110 that includes a client-side application 200, which will be described in greater detail below with reference to FIG. 2. Likewise, providers (e.g., merchants, advertisers, marketers, etc.) may interact with the node 105 using a provider communications device 120, such as general purpose computing system. In some embodiments, providers may establish offers and otherwise interact with the node 105 via web-based graphical user interfaces. Moreover, in some instances, rather than using a communications device 110 that executes a client-side application, end users may also interact with the node 105 via web-based graphical user interfaces.

The communications device 110 and the node 105 may be communicatively coupled via a communications path 115. It is noteworthy to mention that the communications path 115 may include any one (or combination) of private or public communications networks such as the Internet. The node 105 may also be configured to communicatively couple with one or more social network systems 120 via, for example, application programming interfaces (APIs).

According to some embodiments, the node 105 may be implemented within a cloud-based computing environment. In general, a cloud-based computing environment is a resource that typically combines the computational power of a large grouping of processors and/or that combines the storage capacity of a large grouping of computer memories or storage devices. For example, systems that provide a cloud resource may be utilized exclusively by their owners, such as Google™ or Yahoo! ™; or such systems may be accessible to outside users who deploy applications within the computing infrastructure to obtain the benefit of large computational or storage resources.

The cloud may be formed, for example, by a network of web servers, with each web server (or at least a plurality thereof) providing processor and/or storage resources. These servers may manage workloads provided by multiple users (e.g., cloud resource consumers or other users). Typically, each user places workload demands upon the cloud that vary in real-time, sometimes dramatically. The nature and extent of these variations typically depend on the type of business associated with the user.

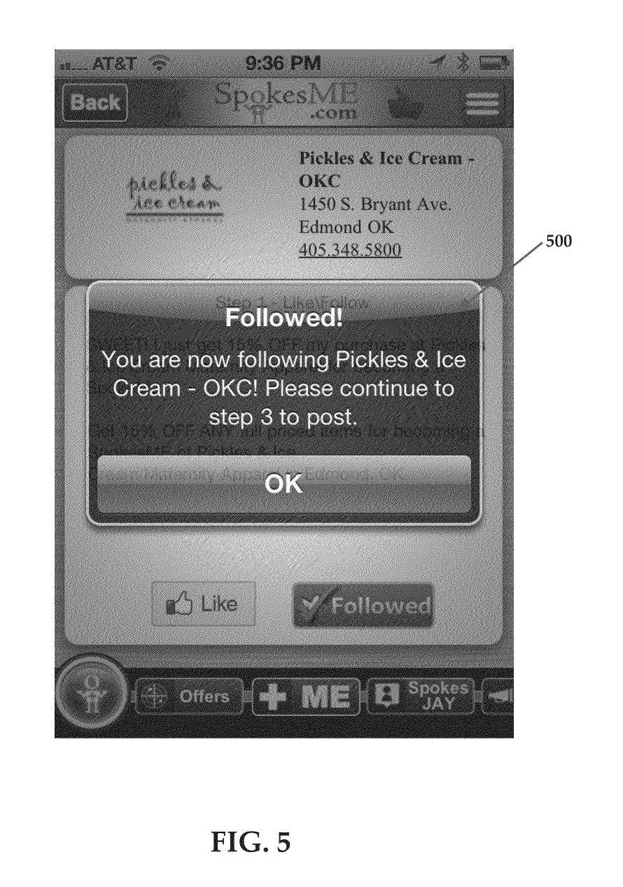

According to some embodiments, the communication device 110 may comprise a client-side application 200 that allows end users to interact with a server-side application 205 that executes on the node 105. The client side application 200 may be executed on a communications device 110, such as a cell phone, tablet, personal computer, or other suitable computing system. These communications devices may include any general purpose computing device, such as the computing system 500 of FIG. 5, which executes the client side application 200.

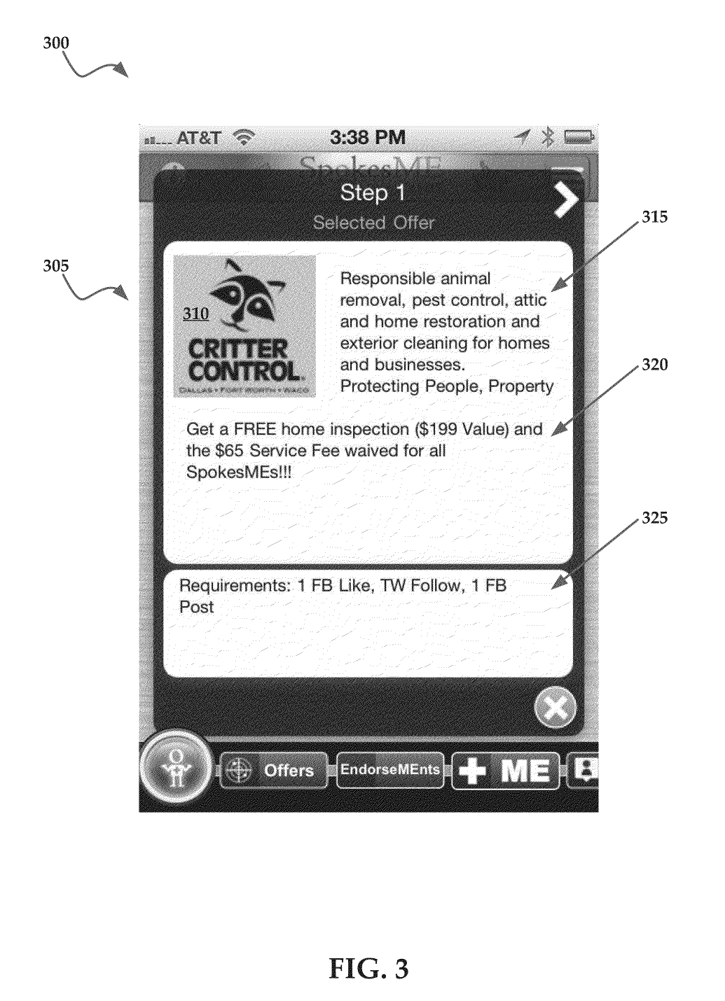

According to some embodiments, the client side application 200 may comprise a user interface generator that may be executed to generate various types of user interfaces that may be utilized by an end user to input data and interact with the node 105. Exemplary user interfaces generated by the user interface module are illustrated in FIGS. 3-8, which will be described in greater detail infra. Additionally, the client side application 200 may provide the node 105 with data regarding the communications device 110, such as location-based information as well as other information that may assist the node 105 in interacting with the communications device 110.

FIG. 2 includes a block diagram of a server-side application 205 that executes on the node 105. More specifically, the server-side application 205 may comprise a communications module 210, an offer module 215, an analysis module 220, a verification module 225, and a provisioning module 230. It is noteworthy that the server-side application 205 may include additional modules, engines, or components, and still fall within the scope of the present technology. As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality. In other embodiments, individual modules of the server-side application 205 may include separately configured web servers.

Generally speaking, providers, also referred to generally throughout as merchants, advertiser, marketers, and the like, may desire to engage in incentivized social advertising using the present technology. Incentivized social advertising may include communication of general or personalized consumer messages on social networks in exchange for a reward from a merchant. Incentivized social advertising may also include “liking”, “following”, “subscribing” and/or other similar activities that are commonly conducted within social networks and that benefit the provider. Benefits may include, but are not limited to, increased brand recognition and increased goodwill with customers.

The communications module 210 may be utilized to facilitate communication between the communications device 110 of the end user and providers through the node 105, as well as between the node 105 and the social network systems 120. Additionally, providers may provide reward usage feedback or other reward usage information back to the node 105 such that reward redemption and usage by end users may be accounted for. Again, the communications module 210 may utilize any number of APIs or other data communication protocols for exchanging data between the components that are communicatively couplable with the node 105. These communications protocols may include secure or insecure methods of communicating data.

According to some embodiments, the offer module 215 may be executed by an advertiser (also known as a provider) prior to communicating the offer to the customer or potential customer. The offer module 210 may be configured to provide the advertiser with one or more advertising campaigns that can be tailored to the needs of the advertiser. In other instances, advertisers may build their advertising campaigns from scratch. Regardless of the method used, advertisers may determine the composition of offers that are to be provided to end users of social networks.

Broadly speaking, an offer may comprise criteria for receiving a reward. That is, the advertiser may select actions, behaviors, activities, and/or other similar functions that are to be executed by end users prior to receiving a reward from the advertiser. According to some embodiments, the criteria may at least comprise requirements for an endorsement of the provider that is to be placed on at least one social network. By way of non-limiting examples, an advertiser may specify various qualitative, quantitative, subjective, objective, or other types of requirements for endorsements that are to be placed by end users on social networks. A provider may specify that an endorsement is to include at least one hundred characters and/or must include at least three action words. Additionally, the provider may specify that the sentiment of the endorsement should be positive. Other permutations of requirements, which would be envisioned by one of ordinary skill in the art with the present disclosure before them are likewise contemplated for use in accordance with the present technology.

In various embodiments, the provider may select one or more predefined endorsements that are to be provided to the end user. That is, rather than allowing the end user to create their endorsement in whole, or in part, the provider may provide the end user with one or more selectable endorsement messages. Thus, providers can control the content of the messaging included in the endorsements of end users.

According to some embodiments, the criteria included in an offer may also comprise other actions that are to be performed by end users. In some instances, criteria may include liking, following, selecting, subscribing, joining, connecting, or otherwise indicating an approval or preference for the provider on a social network, webpage, newsfeed, and so forth. For example, the criteria of an offer may specify that the end user should “like” a social network page associated with the provider that created the offer. It will be understood that an offer may comprise any permutation or quantity of the aforementioned criteria.

After providers create offers, these offers may be communicated to end users of social networks in a variety of manners. In some instances, the analysis module 220 may be executed to determine target endorsers to which offers are to be communicated. That is, the provider may specify requirements for endorsers that allow offers to be targeted to end users. For example, the analysis module 220 may select an end user by determining a number of connections for the end user and comparing the number of connections to a threshold value. Thus, endorsers with a number of connections that meets or exceeds the threshold value are provided an offer. In this example, end users may be targeted for offers because the audience of the end user is large. Therefore, when end users post their endorsements on one or more social networks, it is understood that the endorsement will be communicated to each of the connections of the end user in an effective manner. In some instances, rewards of greater value may be provided to the end user based upon an aggregated number of social connections of the end user. Thus, end users may be incentivized to grow their social networks to receive better offers from providers.

According to some embodiments, the analysis module 220 may deliver offers to end users based upon their location. For example, end users in a city that is serviced by a particular merchant may receive offers from that merchant. The location of the end user may be determined from various sources, including location-based data generated by the communications device 110.

In other instances, the analysis module 220 may select a target endorser by analyzing content on a social network and determining users of the social network that have posted content on the social network that corresponds to a product or service offered by an provider. For example, if an end user mentions a product, service, or a merchant by name, the analysis module 220 may target these individuals to receive offers from the merchant.

The analysis module 220 may also target specific end users based upon other criteria that indicate that the end user will likely respond to an offer from a particular provider. The analysis module 220 may utilize web analytics, demographic, psychographic, or other types of objective and/or subjective criteria that are indicative of the end user to determine if the end user may respond to a particular offer. For example, an end user may indicate their birth date in a social network profile or in a message placed on a social network. Using this information, the analysis module 220 may target specific offers to the end user based upon their determined birth date. While this is only a rudimentary example, many types and permutations of end user preferences or information may be used as the basis for communicating offers to the end user.

Additionally, the analysis module 220 may determine information that assists the provider in determining the criteria that should be included in an offer. For example, if the analysis module 220 determines that the end user only uses specific types of social networks, it would not be advantageous for the provider to require that the end user post their endorsement to a social network that they infrequently utilize. Thus, the analysis module 220 may determine the social networks utilized most frequently by the end user.

In addition to specifying the criteria for the offer, the provider may also establish a reward that is to be provided to the end user upon completion of the criteria. For example, a reward may comprise a coupon, a discount, a ticket, a prize, and so forth. The reward may be either physical or virtual. For example, the reward may comprise a coupon that is mailed to the end user. In other examples, the reward may be embodied in a quick response (QR) or barcode that is provided to the end user via a graphical user interface, an email communication, a short message service (SMS) message, or other mechanism that would be known to one of ordinary skill in the art with the present disclosure before them. For example, the end user may redeem their reward by presenting the QR code to the advertiser who scans the QR code.

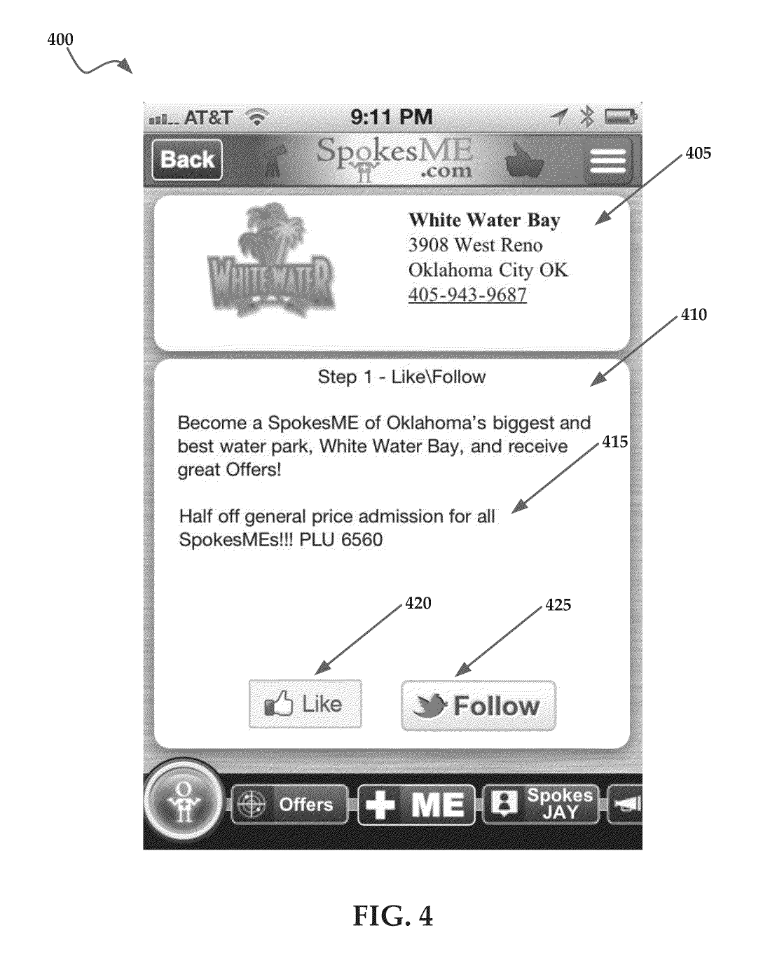

After receiving offer criteria from an provider and determining target end users, the offer module 215 may then communicate the offer to an endorser (e.g., target end users of social networks) via the client-side application 200. The offer may be provided to the end user as a graphical user interface in the form of an offer page, such as the exemplary offer pages 300 and 400 of FIGS. 3 and 4, respectively, which will be discussed in greater detail below.

Depending upon the criteria included in the offer, the end user may be required to complete one or more steps specified in the offer. For example, the end user may be required to input an endorsement, “follow” the provider on at least two social network pages of the provider, and post the endorsement to the social network account of the end user. Again, these are merely exemplary criteria and each offer may include a different set of criteria that are defined by the provider/advertiser/merchant.

In some instances, completion of the criteria may be facilitated by way of a graphical user interface in the form of a criteria completion page 500, as shown in FIG. 5, which will be described in greater detail below. The offer module 215 may provide the end user with one or more easily selectable options such as buttons, that when selected, cause a desired effect, such as a “follow”, “like”, “join mobile alerts”, “join rewards program” or other similar action that would be commonly used by an provider relative to a social network. Thus, rather than requiring the end user to manually navigate to the social network page of a provider, the end user may select a button on a graphical user interface that is presented to the end user.

The end user may provide authenticating credentials (e.g., username and/or password) that may be utilized by the application 205 to interact with the social network account of the end user on their behalf. Thus, when an end user select a button to “follow” a social network page of an advertiser, the communications module 210 may communicate authentication credentials of the end user, as well as instructions that cause the social network account of the end user to “follow” the social network page associated with the provider.

In some instances, the end user may link one or more social network accounts to a profile for the end user. That is, the end user may establish a profile that is stored by the application 205. End users may specify various preferences, demographic data, or other types of information that may assist the application 205 in selecting offers that may be appropriate for the end user. The profile may also include authentication information or credentials such as username and password for the end user that allows the system to “link” the social network account of the end user to their profile. Again, these profiles may be stored in a database associated with the node 105, or may alternatively be stored on the end user communication device 110. Additionally, pertinent portions of content included in posts to a social network account may also be stored in the database, along with other information that may be of benefit to the social connections of the end user or a merchant.

The application 205 may also allow for manual completion and verification of criteria by end users. For example, the verification module 225 may be executed to verify or confirm the execution of the criteria by the end user. The verification module 225 may monitor the social networks of both the end user and the provider to confirm that the criteria have been satisfied. Assuming that the criteria include “liking” a social network page associated with the provider, the verification module 225 may evaluate the social network page of the provider to determine if the end user has, in fact, “liked” or followed the social network page. In some instances, the verification module 225 may utilize authentication credentials associated with the provider to gain access to metrics provided for the provider by the social network system.

Regardless of whether criteria are completed manually or otherwise, the criteria may at least include the posting of an endorsement on a social network account of the end user. Again, the endorsement may comprise a free form message that is created by the end user. These free form messages may also be referred to as a “personalized” endorsement, although some predetermined and selectable endorsements may be created by the present technology to have the appearance of being “personalized” or free form. In some instances, the verification module 225 may verify that the content of a free form endorsement corresponds to the requirements established by the provider. For example, the verification module 225 may search the endorsement for negative or undesirable keywords (e.g., profanity, negative words, brand names of competitors, etc.). Additionally, the verification module 225 may ensure that the promotional message is of sufficient length. For example, the endorsement may be required to include at least one hundred characters. If the endorsement does not pass verification, the endorser may be allowed to edit or replace their current endorsement.

In other embodiments, the endorsement may comprise one or more selectable endorsements that are approved by the provider. In various embodiments, the endorsement may comprise free form and predefined portions. The endorsement may also include various images such as logos, trade names, or other branding associated with the provider. The endorsement may also include various links to the provider and/or specific products and/or services offered by the provider.

The provisioning module 230 may be executed to provide a reward to the endorser upon confirmation of placement of the endorsement on the social network. Again, the reward may comprise a virtual and/or physical reward that is communicated to the end user via any one of a number of mechanisms. It will be understood that the step of providing a reward to the endorser may only comprise the communication of a completion signal or message to the provider that informs the provider that the end user has completed the criteria included in the offer. Thus, the provider may “provide” the reward to the end user outside the confines of the application 200, which would typically occur in embodiments where the reward is embodied in a physical medium.

After endorsements have been placed on the social network account of the end user, the analysis module 220 may monitor the social network account of the end user, and specifically, the endorsement of the end user to determine if the endorsement has generated input or commentary from additional end users. For example, another social network user that is a connection of the endorser may comment about, or signify their interest in the endorsement. These interactions with the endorsement of the endorser may indicate that the additional social network user is a suitable target for the same or similar offer. Once the analysis module 220 has determined additional social network users that may be interested in receiving an offer, the offer module 215 may again be execute to provide an offer to these additional parties. The offer module 215 may also target negative responses by providing different types of offers that may incentivize the end user.

According to some embodiments, the analysis module 220 may evaluate a response type for at least one of the connections that provided a response. For example, the analysis module 220 may employ keyword searching of responses to determine if the response is clearly positive, clearly negative, or somewhere in-between. Using this information, the offer module 215 may tailor the offer to the response type. If the response type is clearly positive, the offer module 215 may provide the same offer to the responder. If the response type is clearly negative or skeptical, the offer module 215 may change the offer to entice the responder into trying the advertiser's product and/or service. For example, the offer module 215 may increase the value of the reward that is included in the offer.

FIG. 3 is a graphical user interface in the form of an exemplary offer page 300. The offer page 300 is shown as comprising exemplary promoter information 305 that includes details about a promoter (e.g., merchant, advertiser, marketer, etc.) of the offer. The promoter information may comprise a logo 310, a summary 315 of the services or products offered by the promoter, as well as a reward description 320. Advantageously, the reward description 320 may include descriptive information regarding the reward that is to be provided to the end user upon placement of an endorsement on the social network account of the end user.

Additionally, the offer page 300 may comprise a criteria section 325 that includes all (or a portion of) the criteria established by the promoter. Again, these criteria (or at least a portion thereof) may be completed before the provision of the reward described in the reward description 320.

FIG. 4 is a graphical user interface in the form of another exemplary offer page 400. The offer page 400 is shown as comprising a promoter section 405 that includes contact and location information for the promoter, as well as a logo or branding for the promoter.

The offer page 400 also includes a summary section 410, which informs the end user about the promoter and encourages the end user to become an endorser. The offer page 400 also comprises a reward section 415 that defines the reward which is to be provided to the end user upon completion of the criteria, including the posting of an endorsement to the social network.

The offer page 400 also includes a criteria section, which, in this instance, comprises two criteria action buttons 420 and 425. The criteria action button 420, when clicked by the end user, causes the application to “like” the Facebook® page of the promoter, via the Facebook® account of the end user. The criteria action button 425, when clicked by the end user, causes the application to “like” the Twitter® feed of the promoter, via the Twitter® account of the end user.

FIG. 5 is a graphical user interface in the form of an exemplary criteria verification popup 500. The verification popup 500 provides the end user (e.g., endorser) with a message that informs the end user that they have completed a step of “following” a particular provider.

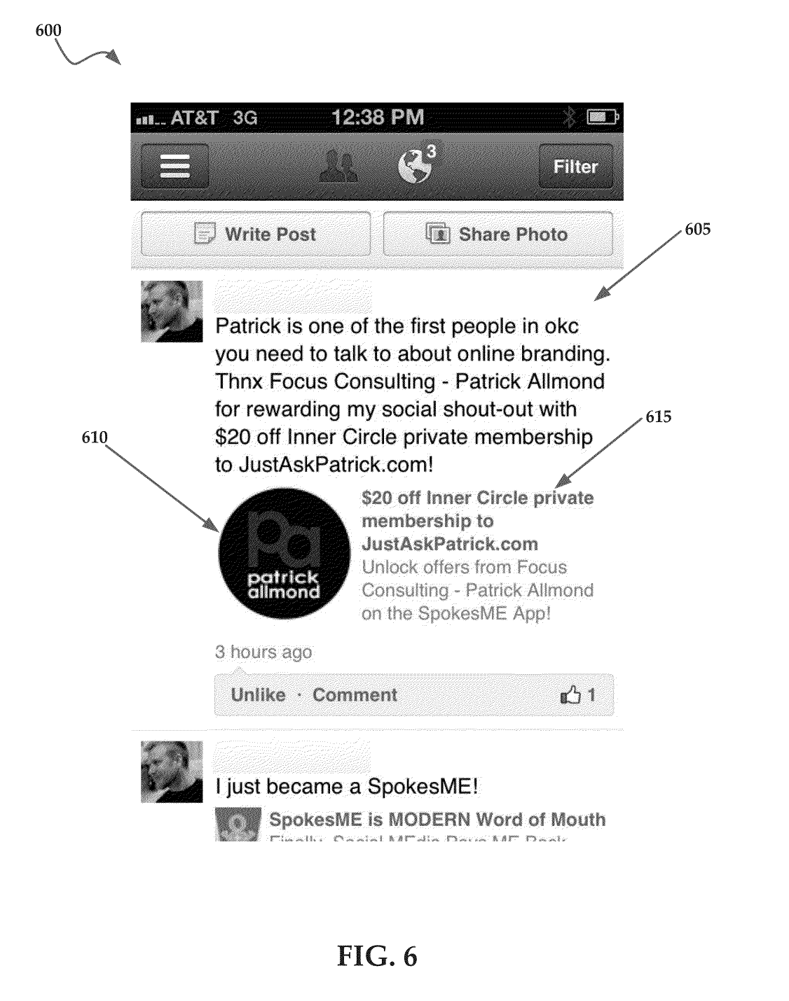

FIG. 6 is a view of a portion of another social network feed 600 for a particular end user. The social network feed 600 is shown as comprising an endorsement 605 that includes message from an end user. The endorsement also comprises a logo 610 that identifies the promoter, as well as a link 615 that is associated with the website of the promoter.

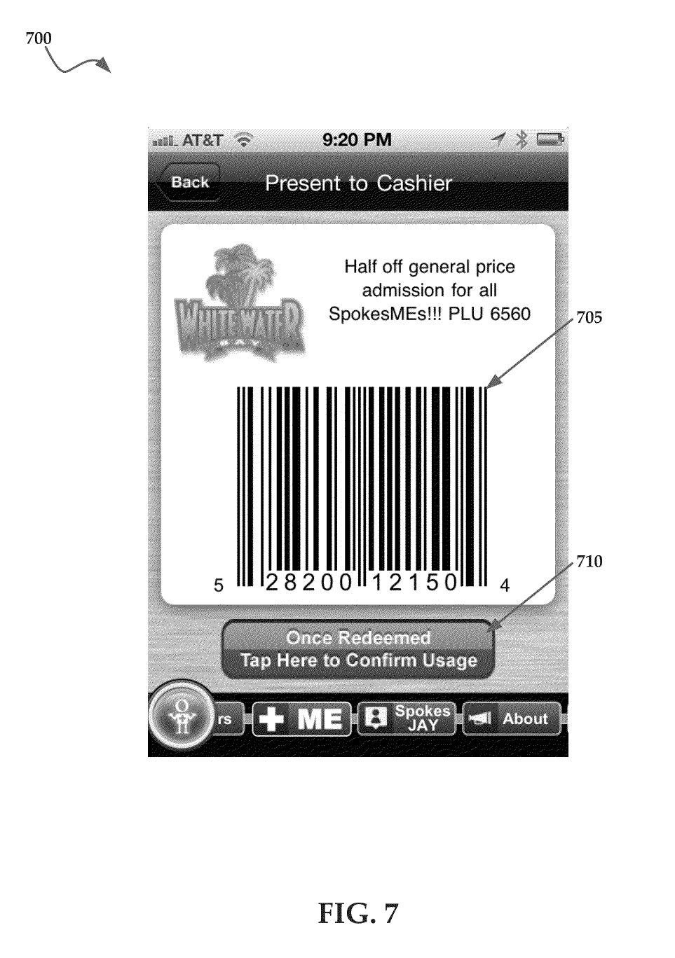

FIG. 7 is a graphical user interface in the form of an exemplary virtual reward 700. In this example, the exemplary virtual reward 700 comprises a coupon that includes a description of the reward, as well as a barcode 705 that may be scanned by the promoter, allowing the reward to be redeemed by the end user. The interface may also include a button 710 that confirms the usage of the reward. The present technology may track issued and redeemed rewards to ensure that end users are only allowed to redeem rewards in accordance with the rules set forth by the promoter. Thus, reward redemption data back communicated back to the node 105 by the promoter may be compared against the rewards issued to endorsers to determine if the endorsers are actually utilizing their rewards. This feedback information may be used as the basis for modifying future offers. For example, if it is determined that relatively few rewards are being redeemed, the provider may choose to change the offer.

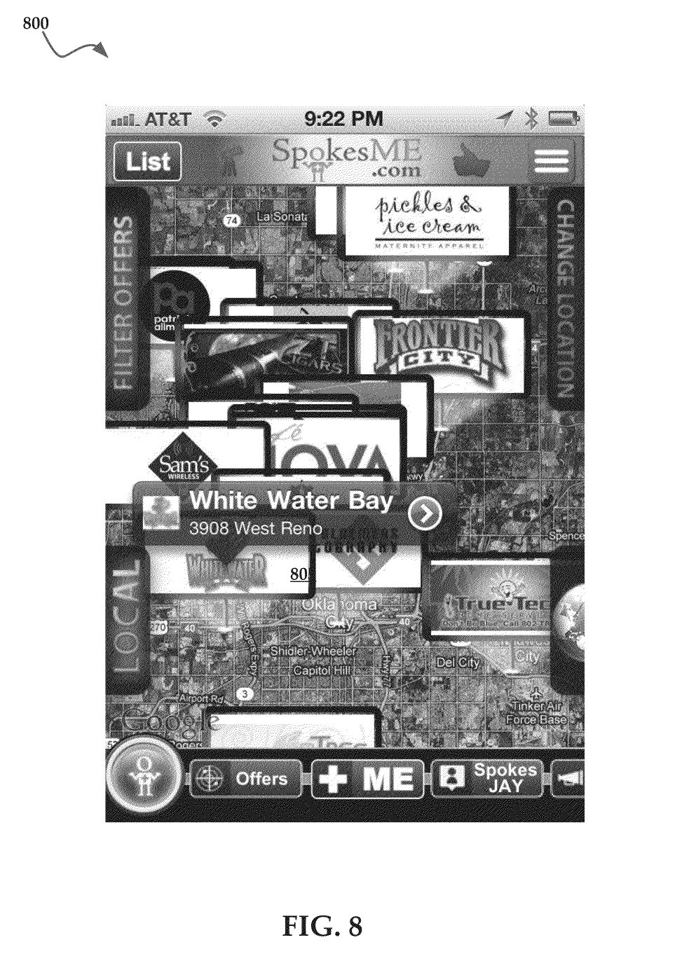

FIG. 8 is an exemplary view of an exemplary map that includes location based offers from promoters. The exemplary map 800 is shown as comprising a plurality of offers, such as offer 805 for “White Water Bay”, which are placed onto the map 800. These offers may be visually represented by icons that include the logo or name associated with the promoter of an offer. The map 800 may include all offers within the area included on the map. In other instances, the end user may filter the offers according to type, such as restaurants, entertainment, etc., although other types of filtering that would be known to one of ordinary skill in the art are likewise contemplated for use in accordance with the present technology. The selection of the map and offers may be based upon geolocation data received from the communications device 110 upon which the application is being executed. When the offer 805 is selected, the exemplary offer pages 400 of FIG. 4 may be displayed to the end user.

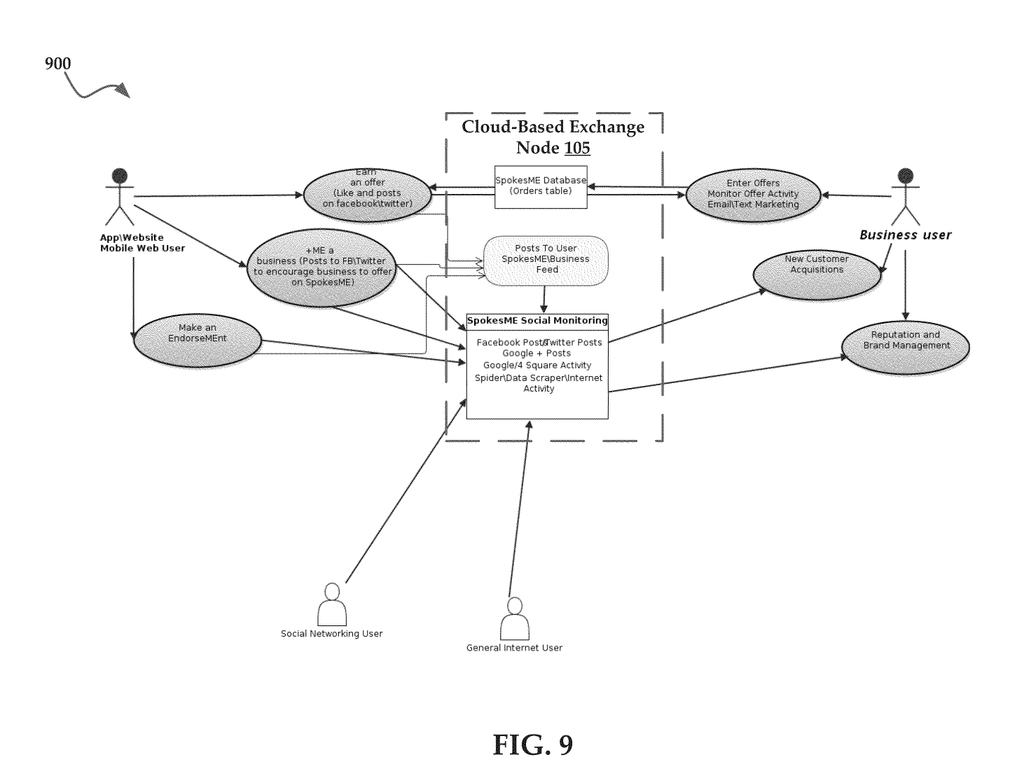

FIG. 9 is an exemplary flow diagram of data through the node 105. Generally speaking, an end user can interact with the node 105 by providing an endorsement, attempting to earn an offer by “liking” or “following” the social network account of a promoter, and/or utilize a unique +ME functionality where the end user can post to various social network accounts of a promoter to encourage the promoter into sending an offer to the end user.

The node 105 may receive offers from providers (e.g., business users) that are stored in a database associated with the node 105. These offers may be delivered to the end users via any number of communications means, such as text messages, emails, social network posts, and so forth. The placement of offers and responses to these offers may be executed using various social network systems. Once posted, the node 105 may monitor the social network systems for end user and/or business user activity, such as posts, commentary, approval (e.g., a like, a follow, etc.), and so forth. The node 105 may also evaluate sentiments or keywords included in the social network activity to determine if the activity is positive or negative. The analytical data determined by the node 105 may be utilized by the business user in acquiring new customers and assisting in reputation and brand management.

Third parties such as social network connections of the end user (or even unassociated end users) may view the endorsements placed on the social network account of the end user. These third parties may comment on the endorsements and may also be targeted for offers by the business user.

As mentioned above, offers, rewards, and redemption information may be tracked and stored in the database associated with the node 105. Thus, business users may track the redemption of rewards that were provided to end users to infer the effectiveness of a particular campaign.

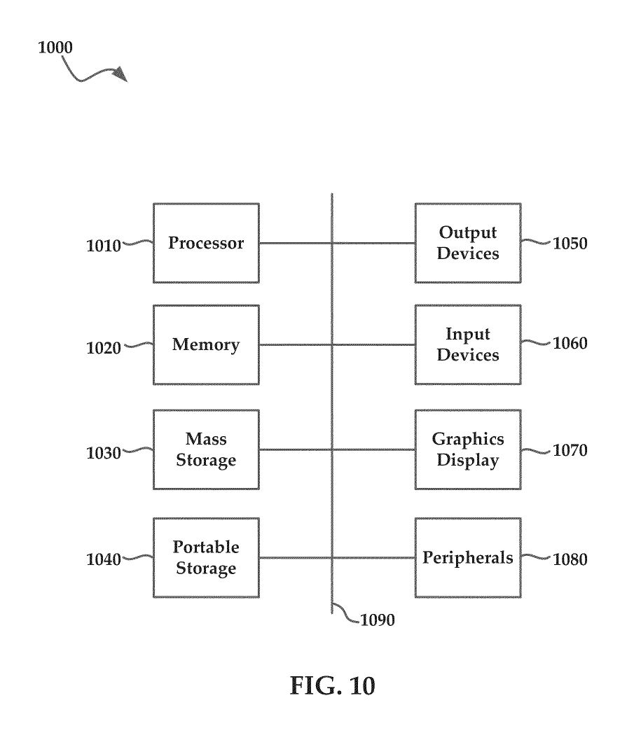

FIG. 10 illustrates an exemplary computing system 1000 that may be used to implement an embodiment of the present technology. The system 1000 of FIG. 10 may be implemented in the contexts of the likes of computing systems, networks, servers, or combinations thereof. The computing system 1000 of FIG. 10 includes one or more processors 1010 and main memory 1020. Main memory 1020 stores, in part, instructions and data for execution by processor 1010. Main memory 1020 may store the executable code when in operation. The system 1000 of FIG. 10 further includes a mass storage device 1030, portable storage medium drive(s) 1040, output devices 1050, user input devices 1060, a graphics display 1070, and peripheral device(s) 1080.

The components shown in FIG. 10 are depicted as being connected via a single bus 1090. The components may be connected through one or more data transport means. Processor unit 1010 and main memory 1020 may be connected via a local microprocessor bus, and the mass storage device 1030, peripheral device(s) 1080, portable storage device 1040, and graphics display 1070 may be connected via one or more input/output (I/O) buses.

Mass storage device 1030, which may be implemented with a magnetic disk drive or an optical disk drive, is a non-volatile storage device for storing data and instructions for use by processor unit 1010. Mass storage device 1030 may store the system software for implementing embodiments of the present invention for purposes of loading that software into main memory 1020.

Portable storage medium drive(s) 1040 operates in conjunction with a portable non-volatile storage medium, such as a floppy disk, compact disk, digital video disc, or USB storage device, to input and output data and code to and from the computer system 1000 of FIG. 10. The system software for implementing embodiments of the present invention may be stored on such a portable medium and input to the computer system 1000 via the portable storage medium drive(s) 1040.

Input devices 1060 provide a portion of a user interface. Input devices 1060 may include an alphanumeric keypad, such as a keyboard, for inputting alpha-numeric and other information, or a pointing device, such as a mouse, a trackball, stylus, or cursor direction keys. Additionally, the system 1000 as shown in FIG. 10 includes output devices 1050. Suitable output devices include speakers, printers, network interfaces, and monitors.

Graphics display 1070 may include a liquid crystal display (LCD) or other suitable display device. Graphics display 1070 receives textual and graphical information, and processes the information for output to the display device.

Peripheral device(s) 1080 may include any type of computer support device to add additional functionality to the computer system. Peripheral device(s) 1080 may include a modem or a router.

The components provided in the computer system 1000 of FIG. 10 are those typically found in computer systems that may be suitable for use with embodiments of the present invention and are intended to represent a broad category of such computer components that are well known in the art. Thus, the computer system 1000 of FIG. 10 may be a personal computer, hand held computing system, telephone, mobile computing system, workstation, server, minicomputer, mainframe computer, or any other computing system. The computer may also include different bus configurations, networked platforms, multi-processor platforms, etc. Various operating systems may be used including Unix, Linux, Windows, Macintosh OS, Palm OS, Android, iPhone OS and other suitable operating systems.

It is noteworthy that any hardware platform suitable for performing the processing described herein is suitable for use with the technology. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, and any other magnetic storage medium, a CD-ROM disk, digital video disk (DVD), any other optical storage medium, RAM, PROM, EPROM, a FLASHEPROM, any other memory chip or cartridge.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A method for exchanging rewards for endorsements on a social network, the method comprising:
receiving, via a server, an offer from a provider, the offer comprising criteria for receiving a reward, the criteria at least comprising requirements for an endorsement of the provider that is to be placed on at least one social network;
providing the offer to an endorser; and
providing, via the server, a reward to the endorser upon confirmation of placement of the endorsement on the social network.

2. The method according to claim 1, further comprising selecting the endorser by determining a number of connections for the endorser and comparing the number of connections to a threshold value, wherein endorsers with a number of connections that meets or exceeds the threshold value are provided an offer.

3. The method according to claim 1, further comprising selecting the endorser by analyzing content on a social network and determining users of the social network that have posted content on the social network that corresponds to a product or service offered by a provider.

4. The method according to claim 1, further comprising selecting the offer of the provider based upon a location of the endorser.

5. The method according to claim 1, further comprising selecting the offer based upon endorser generated content.

6. The method according to claim 1, further comprising providing, via the server, the personalized endorsement to the social network for placement thereon.

7. The method according to claim 1, further comprising receiving authentication credentials for the endorser relative to the at least one social network and authenticating the endorser prior to the step of providing the personalized endorsement to the social network for placement thereon.

8. The method according to claim 1, further comprising providing the criteria to the endorser via a graphical user interface and providing feedback that corresponds to completion of the criteria to via the graphical user interface.

9. The method according to claim 1, further comprising monitoring the at least one social network of the endorser for responses from connections of the endorser to the endorsement.

10. The method according to claim 9, further comprising providing the offer to at least one of the connections of the endorser that provided a response.

11. The method according to claim 9, further comprising determining a response type for at least one of the connections that provided a response; and providing an offer to the at least one of the connection that corresponds to the response type.

12. The method according to claim 1, wherein the personalized endorsement comprises a minimum number of characters.

13. The method according to claim 12, wherein the personalized endorsement comprises one or more selectable endorsements, the endorser selecting at least one of the one or more selectable endorsements.

14. The method according to claim 12, wherein the personalized endorsement comprises a link to any of a website of the provider, a product or service of the provider, or any combinations thereof.

15. A system for exchanging rewards for personal endorsements on a social network, the system comprising:
a memory for storing executable instructions;
a processor for executing the executable instructions stored in memory, the executable instructions comprising:
an offer module stored in memory and executable by the processor to:
receive an offer from a provider, the offer comprising criteria for receiving a reward, the criteria at least comprising requirements for a personalized endorsement of the provider that is to be placed on at least one social network; and
provide the offer to an endorser;
an analysis module stored in memory and executable by the processor to determine completion of the criteria; and
a provisioning module stored in memory and executable by the processor to provide a reward to the endorser upon the placement of the personalized endorsement on the social network.

16. A method for incentivizing sharing of promotional messages, the method comprising:
providing an offer to an endorser, the offer comprising criteria for receiving a reward, the criteria at least comprising requirements for a promotional message for a provider that is to be communicated to at least one third party via a social network account; and
providing a reward to the endorser upon the communication of the promotional message to the at least one third party via the social network account.

17. The method according to claim 16, wherein the promotional message is provided to the at least one third party via at least one social network account associated with the endorser.

18. The method according to claim 16, further comprising verifying the communication of the promotional message to the at least one third party before the step of providing a reward to the endorser.
